(19) United States
(12) Patent Application Publication
(10) Pub. No.: US 2024/0336742 A1
(43) Pub. Date: Oct. 10, 2024

(54) SILICONE-MODIFIED POLYESTER RESIN AND POWDER COATING COMPOSITION COMPRISING THE SAME

(71) Applicant: KCC CORPORATION, Seoul (KR)

(72) Inventors: Do Kyun Kim, Hwaseong-si (KR); Hui Cheol AN, Yongin-si (KR); Yeon Joo LEE, Suwon-si (KR); Hyeon Min SHIN, Jeonju-si (KR)

(21) Appl. No.: 18/444,652

(22) Filed: Feb. 17, 2024

(30) Foreign Application Priority Data
Apr. 5, 2023 (KR) 10-2023-0044575

(51) Int. Cl. C08G 77/445; C09D 5/03; C09D 167/02; C09D 183/10

(52) U.S. Cl. CPC C08G 77/445; C09D 5/03; C09D 167/02; C09D 183/10

(57) ABSTRACT

Provided are a silicone-modified polyester resin having excellent mechanical properties, weatherability, and hydrolysis resistance, and a powder coating composition containing the same.

### RELATED APPLICATION DATA

This application claims the benefit of South Korean Application No. 10-2023-0044575, filed Apr. 5, 2023, the disclosure of which is incorporated herein by reference in its entirety.

### BACKGROUND

### 1. Field

Embodiments relates to a silicone-modified polyester resin having excellent mechanical properties, weatherability, and hydrolysis resistance, and a powder coating composition containing the same.

### 2. Description of the Related Art

Powder coating compositions, which are widely applied for coating of exterior materials and various facilities, require excellent weatherability, corrosion resistance, and mechanical properties. According to the level of weatherability, powder coatings are certified as Qualicoat Class-1, Class-1.5, Class-2 (Super durable), and Class-3 (Hyper durable), and a polyester-based resin prepared by containing isophthalic acid is mainly applied to Class-1 to 2 coatings, and an ultra-high weatherability fluororesin is applied to a Class-3 coating.

The polyester-based resin prepared by including the isophthalic acid contains carboxylic acid as a terminal functional group, and may use an epoxy curing agent (BPA epoxy or TGIC) as a curing agent to form a cured coating film by an acid-epoxy reaction with a glycidyl ring, or may use hydroxy-alkyl-amide (HAA) as a curing agent to form a cured coating film by an acid-hydroxyl group condensation reaction. The cohesive energy of the cured coating film prepared through the acid-epoxy reaction or the acid-hydroxyl condensation reaction is low compared to the cohesive energy of an urethane bond, thus a coating using a polyester-based resin containing a carboxylic acid as the terminal functional group has low resistance to external stimuli.

Meanwhile, in the case of the fluororesin, the fluororesin has excellent weatherability due to properties of fluorine itself and an urethane bond obtained by an alcohol-isocyanate (OH—NCO) curing structure, but is expensive, and thus, has a limitation of weakening the price competitiveness of a coating to which the fluororesin is applied.

Therefore, there is a need for the development of a polyester resin that is competitive in price compared to a fluororesin, while having an urethane bond after curing, thereby having mechanical properties, weatherability, and hydrolysis resistance equivalent to those of the fluororesin.

### SUMMARY

An aspect of the present invention provides a silicone-modified polyester resin having excellent mechanical properties, weatherability, and hydrolysis resistance, and a powder coating composition containing the same.

According to at least one of embodiments, there are provided a silicone-modified polyester resin having a glass transition temperature of 35° C. or higher, and a hydroxyl value of 20 to 100 mgKOH/g, and a powder coating composition containing the same.

### EFFECT OF THE INVENTION

An aspect of the present invention provides a silicone-modified polyester resin having excellent mechanical properties, weatherability, and hydrolysis resistance, and a powder coating composition containing the same. The silicone-modified polyester resin according to the present invention is competitive in price compared to a fluororesin, while providing mechanical properties, weatherability, and hydrolysis resistance equivalent to those of the fluororesin. In addition, the silicone-modified polyester resin of the present invention has a high glass transition temperature, and thus may stably maintain a powder state at room temperature.

The powder coating composition according to the present invention including the silicone-modified polyester resin may be applied to steel sheet coating, etc., and may form a highly weatherable powder coating film that exhibits excellent gloss retention rate, color retention rate, and chalking resistance even under long-term exposure to a high-temperature and high-humidity climate environment with strong ultraviolet rays.

### DETAILED DESCRIPTION

Hereinafter, the present invention will be described. However, the present invention is not limited only by the following description. Each component may be variously modified or selectively mixed and used if necessary. Therefore, it is to be understood that all changes, equivalents, and alternatives falling within the spirit and scope of the present invention are intended to be included.

The “number average molecular weight” used herein is measured by a typical method known in the art, and may be measured by, for example, a gel permeation chromatograph (GPC) method. The functional group value such as a “hydroxyl value” and an “acid value” is measured by a typical method known in the art, and may be measured by, for example, a titration method. The “softening point” is measured by a typical method known in the art, and may be measured using, for example, a dropping point system calorimetry DP70 by Mettler Toledo Co. The “glass transition temperature” is measured by a typical method known in the art, and may be measured by, for example, a differential scanning calorimetry (DSC) method. The “viscosity” is measured by a typical method known in the art, and may be measured using, for example, a Brookfield viscometer at room temperature (25° C.).

### Silicone-Modified Polyester Resin

A silicon-modified polyester resin of the present invention may have a glass transition temperature of 35° C. or higher, for example, 35 to 50° C., and a hydroxyl value of 20 to 100 mgKOH/g, for example, 40 to 90 mgKOH/g.

The glass transition temperature is a temperature at which a polymer in a solid glass state begins to move with activity due to heat and is changed into a soft rubber state, and the higher the glass transition temperature, the more stable the polymer can be maintained at high temperatures. Since a silicone resin intermediate has a low glass transition temperature, the glass transition temperature of a silicone-modified polyester resin modified with a silicone resin intermediate may also be low. This means that it can be easily changed into a rubber state, and it means that powderization is difficult in a powder resin. As described above, if a powder coating is forcibly prepared using a silicone-modified polyester resin having a low glass transition temperature, storage stability may decrease due to agglomeration of particles during storage.

In the present invention, excellent properties are imparted to a powder coating by controlling the glass transition temperature of a silicon-modified polyester resin to be above a certain level. Specifically, a resin having excellent storage stability, flexibility, and bendability is provided by controlling the glass transition temperature of the silicone-modified polyester resin to be 35° C. or higher, for example, 35 to 50° C. If the glass transition temperature of a silicone-modified polyester resin is below the aforementioned range, storage properties may decrease due to agglomeration and the like.

A hydroxyl group in a silicone-modified polyester resin participates in an alcohol-isocyanate reaction with an isocyanate resin, which is a curing agent, and contributes to the formation of a coating film. The hydroxyl value is a value that indicates the content of a hydroxyl group in a sample, and the hydroxyl value of a silicone-modified polyester resin may affect workability by controlling a curing reaction rate, and may affect weatherability by controlling the number of urethane bonds.

In the present invention, the hydroxyl value of a silicone-modified polyester resin is controlled to be 20 to 100 mgKOH/g, for example, 40 to 90 mgKOH/g, so that a resin having excellent weatherability, adhesion, chemical resistance, stretchability, impact resistance, and flexibility is provided. If the hydroxyl value of the silicone-modified polyester resin is below the aforementioned range, the cross-linking density of a coating film may be decreased, which may decrease weatherability, adhesion, and chemical resistance, and if it is above the aforementioned range, stretchability, impact resistance, and flexibility may be decreased after the curing of a coating film.

In addition, the silicone-modified polyester resin may have a number average molecular weight of 2,500 to 6,000 g/mol, for example, 2,500 to 5,000 g/mol, for another example, 3,000 to 3,500 g/mol, an acid value of 1 to 10 mgKOH/g, a viscosity (200° C.) of 10 to 50 P, and a softening point of 100 to 130° C.

If the number average molecular weight of a silicone-modified polyester resin is below the aforementioned range, adhesion and storage properties of a resin and a coating may be decreased, and if it is above the aforementioned range, the appearance of a coating film, for example, smoothness, may be decreased. If the acid value of a silicone-modified polyester resin is over the aforementioned range, water produced by a reaction with a hydroxyl group during the curing of a coating film may cause degradation in appearance of the coating film, such as the generation of pinholes. If the viscosity of a silicone-modified polyester resin is below the aforementioned range, dispersibility of a coating may be decreased, which may form spots or pinholes, thereby degrading appearance, and if it is above than the aforementioned range, workability and appearance, for example, smoothness, may be impaired. If the softening point of a silicone-modified polyester resin is out of the aforementioned range, layer separation may occur during storage at room temperature and heat resistance may be decreased.

The silicone-modified polyester resin may be prepared from a composition including a polyol monomer, a polyacid monomer, and a silicone resin intermediate. The silicone-modified polyester resin of the present invention may increase the low weatherability and durability of a typical polyester resin by including a silicone resin intermediate, and may apply a hydroxyl group as a functional group, thereby reacting with an isocyanate-based curing agent under a high-temperature curing condition (e.g., 180 to 200° C.) to form a urethane bond, so that a coating film to which the silicone-modified polyester resin is applied may secure superior weatherability to that of a coating film comprising polyester-TGIC and polyester-HAA.

### Polyol Monomer

The silicone-modified polyester resin composition of the present invention includes a polyol monomer. As the polyol monomer, a divalent or higher alicyclic or aliphatic polyol having 2 to 12 carbon atoms may be used, and for example, an alicyclic or aliphatic alcohol including 2 to 4 hydroxy functional groups may be used. The polyol monomer may be, for example, neopentyl glycol, ethylene glycol, propylene glycol, trimethylolpropane, trimethylolethane, cyclohexanedimethanol, 1,6-hexanediol, diethylene glycol, dipropylene glycol, triethylene glycol, 1,3-butylene glycol, 1,4-butylene glycol, 1,5-pentanediol, ditrimethylolpropane, triethylolpropane, glycerin, pentaerythritol, and the like. These may be used alone or in combination of two or more thereof. For example, the polyol monomer may include neopentyl glycol, ethylene glycol, 1,3-butylene glycol, 1,4-butylene glycol, cyclohexanedimethanol, trimethylolpropane, trimethylolethane, or a mixture thereof.

The polyol monomer may contain 10 to 30 equivalent % of a trifunctional or higher aliphatic alcohol monomer based on the total equivalents of alcohol monomers. If the content of the trifunctional or higher aliphatic alcohol monomer is below the aforementioned range, the glass transition temperature is lowered, which may cause solidification and resin blocking, and if it is above the aforementioned range, an ester reaction occurs rapidly, thereby increasing the molecular weight, which may decrease preparation stability by causing gelation and the occurrence of gel particles.

The silicone-modified polyester resin composition may contain 25 to 45 wt %, for example, 25 to 37 wt % of the polyol monomer based on the total weight of the composition. If the content of the polyol monomer satisfies the aforementioned range, reactivity with a silicone resin intermediate and a polyacid monomer is excellent, so that it is possible to control an ester reaction rate, but if it is out of the aforementioned range, reactivity with a silicone resin intermediate and a polyacid monomer is broken, so that it may be difficult to control the reaction rate. For example, if the content of the polyol monomer is below the aforementioned range, the molecular weight may increase to cause a gel state, which may deteriorate resin synthesis stability and appearance, and if it is above the aforementioned range, the glass transition temperature may be lowered due to a small molecular weight, which may decrease shelf-life.

### Polyacid Monomer

The silicone-modified polyester resin composition of the present invention includes a polyacid monomer. As the polyacid monomer, a divalent or higher aromatic, aliphatic, or alicyclic carboxylic acid having 5 to 12 carbon atoms or a derivative thereof may be used, and for example, a bifunctional or higher aromatic, aliphatic, or alicyclic carboxylic acid or a derivative thereof may be used. As the polyacid monomer, for example, a bifunctional or higher aromatic carboxylic acid or a derivative thereof, such as isophthalic acid, terephthalic acid, trimellitic acid, dimethyl terephthalate, dimethyl isophthalate, trimellitic anhydride, or phthalic anhydride; or a bifunctional or higher aliphatic or alicyclic carboxylic acid or a derivative thereof, such as adipic acid, azlaic acid, sebacic acid, succinic acid, cyclohexanedicarboxylic acid, hexahydrophthalic anhydride, methylhexahydrophthalic anhydride, or methyltetrahydrophthalic anhydride may be used. These may be used alone or in combination of two or more thereof. As an example, the polyacid monomer may include isophthalic acid, terephthalic acid, dimethyl isophthalate, or a mixture thereof.

The polyacid monomer may contain 90 to 100 equivalent % of an aromatic carboxylic acid monomer based on the total equivalents of acid monomers. If the content of the aromatic carboxylic acid monomer is below the aforementioned range, the glass transition temperature is lowered, which may cause solidification and resin blocking.

The silicone-modified polyester resin composition may include 20 to 40 wt % of the polyacid monomer based on the total weight of the composition. If the content of the polyacid monomer of the silicone-modified polyester resin composition satisfies the aforementioned range, it is possible to control an ester reaction rate to terminate a reaction at a desired point, but if it is out of the aforementioned range, it may be difficult to control the reaction rate. For example, if the content of the polyacid monomer is below the aforementioned range, the molecular weight may decrease to lower the glass transition temperature, which may decrease shelf-life, and if it is above the aforementioned range, the molecular weight may increase to cause a gel state, which may degrade resin synthesis stability and appearance.

### Silicone Resin Intermediate

The silicone-modified polyester resin composition of the present invention includes a silicone resin intermediate, for example, a solvent-free type silicone resin intermediate.

The polyacid and the polyol are organic compounds derived from petroleum and the like, and may have insufficient compatibility with a silicone resin intermediate, which is an inorganic polymer containing silicon and oxygen. Therefore, it is preferable that a silicone resin intermediate having an organic substituent is used in order to be used together with an organic compound, and depending on the content of the organic substituent, compatibility with an organic compound may vary.

The silicone resin intermediate is classified into an M unit, a D unit, a T unit, and a Q unit according to the number of organic substituents bonded to silicon. Specifically, it is the M unit if there are three organic substituents bonded to silicon and there is one functional group (—O—), the D unit if there are two organic substituents and there are two functional groups, the T unit if there is one organic substituent and there are three functional groups, and the Q unit if there is no organic substituent and there are four functional groups.

The silicone resin intermediate may be a three-dimensional network structure mainly formed of T units, and may be, for example, a compound represented by Formula 1 below.

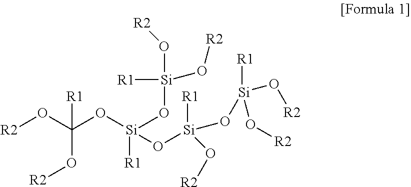

In Formula 1 above,
R1 is methyl, propyl, or phenyl, and
R2 is methyl or hydrogen.

The silicone resin intermediate may contain both an alkyl group and a phenyl group. The alkyl group has a structure capable of forming cross-linking, and thus, may secure stable adhesion by forming smooth cross-linking with the surroundings. The phenyl group is derived from benzene, and is an aromatic hydrocarbon in a stable form in which a sigma bond and a double bond of a pi bond coexists, and may affect compatibility with other organic components constituting a coating, for example, a polyester resin, and the higher the content thereof, the better the compatibility.

In order to increase the compatibility between the silicone resin intermediate and the organic compound and to secure adhesion, the composition of a substituent R1 of the silicone resin intermediate may be adjusted. As an example, as the R1, phenyl and methyl or propyl at a ratio of 1:0 to 1, for example, 1:0.2 to 0.67, may be applied. If the ratio of methyl or propyl to phenyl satisfies the aforementioned range, an alcohol monomer and a silicone resin intermediate may be mixed well. If the ratio of methyl or propyl to phenyl is above the aforementioned range, the molecular weight of a silicone resin intermediate decreases, thereby lowering the glass transition temperature of a final silicone-modified polyester resin, which may cause blocking of a powdered resin and a coating, and appearance may be degraded due to a decrease in compatibility with coating components. On the other hand, if the ratio of methyl or propyl to phenyl is below the aforementioned range, the content of silicon dioxide in a resin and a coating decreases and the aromatic content increases, which may result in a decrease in weatherability.

A reactive functional group in the silicone resin intermediate may be silanol or methoxy, for example, silanol. The content of the reactive functional group in the silicone resin intermediate may be 1 to 40 wt %, for example, 3 to 15 wt %.

If the content of the reactive functional group in a silicone resin intermediate is below the aforementioned range, mechanical properties of a coating film, such as weatherability, impact resistance, and stretchability, may be decreased due to deterioration in copolymerization during the preparation of a silicone intermediate, and appearance defects may occur due to a decrease in compatibility with coating components, and if it is above the aforementioned range, resin preparation stability may be decreased, thereby causing gelation.

The silicone resin intermediate may have a number average molecular weight of 500 to 3,000 g/mol, for example, 800 to 2,500 g/mol, a weight average molecular weight of 1,200 to 4,000 g/mol, for example, 1,500 to 3,000 g/mol, and a softening point of 20 to 85° C.

If the number average molecular weight and the weight average molecular weight of a silicone resin intermediate are below the aforementioned range, the glass transition temperature of a silicone-modified polyester resin is low, which may result in a decrease in storage properties, such as the occurrence of clumping or the like, and if it is above the aforementioned range, the silicon dioxide content decreases and the aromatic content increases, which may result in a decrease in weatherability. If the softening point of a silicone resin intermediate is below the aforementioned range, storage properties may decrease, thereby causing the occurrence of clumping or the like, and if it is above the aforementioned range, flexibility may decrease.

The silicone-modified polyester resin composition may contain 20 to 50 wt %, for example, 25 to 45 wt %, and for another example 25 to 45 wt % of the silicone resin intermediate based on the total weight of the composition. If the content of a silicone resin intermediate is below the aforementioned range, weatherability and heat resistance of a powder coating to which the corresponding silicone-modified polyester resin is applied may decrease. On the other hand, if it is above the aforementioned range, the glass transition temperature is lowered, so that storage properties of a resin and a coating may decrease (occurrence of blocking and clumping), and the preparation stability of a resin may decrease (gelation), and compatibility with coating components decreases, so that a coating may not be properly produced or when the coating is coated, the gloss or color may be inconsistent.

### Method for Preparing Silicone-Modified Polyester Resin

The silicon-modified polyester resin of the present invention may be prepared from a polyol monomer, a silicone resin intermediate, and a polyacid monomer.

If a method of preparing a polyester intermediate by using a polyol and a polyacid, and then modifying the polyester intermediate into a silicone resin intermediate is used, due to a decrease in reaction stability between the polyester intermediate with an increased molecular weight and the silicone resin intermediate, a composite has an excessively increased molecular weight, and thus, is not uniformly mixed, which may generate a gel particle in which a polymer is present in the form of spots, so that a mild reaction should be performed by including a solvent in order to prevent this. However, the method involves the use of a solvent, and thus, is not suitable for the preparation of a solid-phase resin for a powder coating.

In addition, if a polyol and a polyacid are used to prepare a polyester resin, and then a silicone resin intermediate is simply mixed therewith to prepare a coating, a small amount of condensed water may be generated as a curing reaction of the polyester resin and isocinate and a condensation reaction of the polyester resin and the silicone resin intermediate occur, which may result in degradation in appearance, such as the formation of pinholes of a coating film.

A method for preparing a silicone-modified polyester resin according to the present invention may include reacting a polyol monomer with a silicone resin intermediate to prepare a prepolymer, adding a polyacid monomer to the prepolymer and subjecting the mixture to a condensation reaction to prepare a silicone-modified polyester intermediate, and removing condensed water by applying a vacuum. After the condensation reaction, by applying a vacuum to remove condensed water produced by further reacting the silicone-modified polyester intermediate with an acid monomer, it is possible to prevent a problem in which a small amount of remaining water forms pinholes when a coating containing the silicone-modified polyester resin of the present invention is coated and dry-cured.

As an example, a prepolymer may be prepared by introducing an alcohol, a reaction catalyst, and a silicone resin intermediate into a reactor equipped with a stirrer, a thermometer, a nitrogen injection pipe, a packed-column, an H-type separation pipe, and a condenser, and raising the temperature, and then a silicone-modified polyester intermediate having an acid value of 5 to 30 mgKOH/g and a viscosity of 5 to 20 P (175° C., Brookfield viscometer CAP-2000+H) may be prepared by adding carboxylic acid and removing condensed water at 220 to 260° C. while injecting an inert gas. As the reaction catalyst, a titanate-based catalyst, for example, tetraisopropyl titanate (TIPT), may be used.

Thereafter, the packed-column is removed, and decompression is gradually performed to 200 to 100 torr at 210 to 250° C. at atmospheric pressure (760 torr) to remove condensed water with the H-type separation tube, and when the acid value of the silicone-modified polyester resin drops to 5 or below, the decompression process is terminated and the temperature is lowered to 190° C. to prepare a silicone-modified polyester resin having a hydroxyl value of 20 to 100 mgKOH/g, an acid value of 1 to 10 mgKOH/g, a viscosity of 10 to 50 P (Poise, 200° C., Brookfield CAP-2000+H), a softening point of 100 to 130° C., a glass transition temperature of 30 to 50° C., and a number average molecular weight of 2,500 to 6,000 g/mol.

### Powder Coating Composition

A powder coating composition of the present invention includes a silicone-modified polyester resin, a curing agent, and a pigment. The powder coating composition of the present invention may further include, if necessary, an additive commonly used in the art, such as a degassing agent, an antioxidant, a catalyst, a leveling agent, an adhesion promoter, or the like.

As the silicone-modified polyester resin, the aforementioned silicone-modified polyester resin may be used. 40 to 60 wt %, for example, 45 to 55 wt % of the silicone-modified polyester resin may be included based on the total amount of the powder coating composition. If the content of the silicone-modified polyester resin satisfies the aforementioned range, it is possible to provide a coating having excellent mechanical properties, weatherability, and hydrolysis resistance.

The curing agent is not particularly limited as long as it is a curing agent capable of being subjected to a curing reaction with a polyester resin, and for example, an isocyanate-based curing agent may be used. Based on the total amount of the powder coating composition, 5 to 20 wt % of the curing agent may be included. When the content of the curing agent satisfies the aforementioned range, the curing degree of a coating film increases, which may improve the properties of the coating film.

As the pigment, an organic pigment, a metallic pigment, an aluminum-paste (Al-paste), a pearl, and the like may be used without limitation, and these may be used alone or in combination of two or more thereof. Non-limiting examples of an available color pigment include azo-based, phthalocyanine-based, iron oxide-based, cobalt-based, silicate-based, and chromate-based pigments, for example, titanium dioxide, zinc oxide, bismuth vanadate, cyanine green, carbon black, red iron oxide, yellow iron oxide, navy blue, cyanine blue, a mixture of two or more thereof, and the like. Based on the total amount of the powder coating composition, 0.1 to 50 wt %, for example, 30 to 40 wt % of the pigment may be included. When the content of the color pigment satisfies the aforementioned range, the color expression of a coating film is excellent, and the concealment of the coating film may be improved.

The powder coating composition of the present invention may further include, to the extent that it does not harm the intrinsic properties of the coating composition, an additive commonly used in the art, such as a degassing agent, an antioxidant, a catalyst, a leveling agent, an adhesion promoter, or the like. The additive may be appropriately added within a content range known in the art, for example, based on the total weight of the powder coating composition, 0.1 to 20 wt %, for example, 0.1 to 10 wt % of the additive may be included.

The powder coating composition according to the present invention may be prepared by a method known in the art, and as an example, may be prepared by processes such as weighing, premixing, melt-dispersion, and grinding. For example, the powder coating composition may be prepared by introducing a raw-material mixture containing a silicone-modified polyester resin, a curing agent, a pigment, and if necessary, a degassing agent, an antioxidant, a catalyst, a leveling agent, and an adhesion promoter into a container mixer and uniformly mixing the mixture, and melt-mixing the mixed composition followed by griding the same. As an example, the raw material mixture is melt-dispersed at 70 to 130° C. by a melt-kneading device such as a kneader or extruder to prepare a chip to a predetermined thickness (e.g., 1 to 5 mm), and then the prepared chip is ground to a range of 40 to 80 μm using a grinding device such as a high-speed mixer, and then classified to prepare a powder coating composition.

The classification process is not particularly limited, and, for example, filtering may be performed to 40 to 80 mesh. Accordingly, a powder coating having an average particle size of 40 to 80 μm may be obtained. The average particle size of the powder is not particularly limited, but if it satisfies the aforementioned range, the coating workability and the appearance properties of a coating film may be improved.

In order to improve the fluidity of the powder coating, it is also possible to coat the surface of a powder coating particle according to the present invention with fine powder such as silica. As a method for performing such treatment, a grinding mixing method of performing mixing while adding fine powder during grinding or a dry mixing method using a Henschel mixer or the like may be used.

Hereinafter, the present invention will be described in more detail with reference to examples. However, the following examples are merely illustrative of the present invention and are not intended to limit the scope of the present invention.

### Preparation Example 1: Preparation of Silicone-Modified Polyester Resin (A)

Into a four-neck flask for synthesis equipped with a thermometer, a stirring device, an H-shaped separation pipe, a filling column, a condenser, a nitrogen injection pipe, and a heating device, 230 parts by weight of neopentyl glycol, 66 parts by weight of trimethylol propane, 106 parts by weight of cyclohexane dimethanol, and 300 parts by weight of a silicone resin intermediate (Mn 1,200 g/mol, Mw 2,400 g/mol, phenyl/propyl ratio=1:0.37, and softening point 40° C.) were charged, and while introducing nitrogen (10 cc/min) thereto, the temperature was raised to 90° C. to dissolve the polyol and the silicone resin intermediate. When the dissolution was completed, 401 parts by weight of isophthalic acid and 0.5 parts by weight of a catalyst (TIPT) were charged thereinto, and the temperature was raised to 240° C. over 3 to 5 hours while removing condensed water to perform a maintenance reaction. When the acid value of the silicone-modified polyester resin intermediate reached 10, and the viscosity thereof reached 13 P (@175° C., Brookfield CAP 2000+H), the packed column was removed, and the temperature was lowered to 230° C. and the pressure was lowered to 150 torr, thereby removing 106 parts by weight of the condensed water to prepare a silicone-modified polyester resin (A) having a number average molecular weight of 3,500 g/mol, a hydroxyl value of 76 mgKOH/g, an acid value of 4 mgKOH/g, a viscosity of 25 P (@200° C., Brookfield CAP 2000+H), a softening point of 115° C., and a glass transition temperature of 39° C.

### Preparation Example 2: Preparation of Silicone-Modified Polyester Resin (B)

Into a four-neck flask for synthesis equipped with a thermometer, a stirring device, an H-shaped separation pipe, a filling column, a condenser, a nitrogen injection pipe, and a heating device, 318 parts by weight of neopentyl glycol, 68 parts by weight of trimethylol propane, and 303 parts by weight of a silicone resin intermediate (Mn 1,200 g/mol, Mw 2,400 g/mol, phenyl/propyl ratio=1:0.37, and softening point 40° C.) were charged, and while introducing nitrogen (10 cc/min) thereto, the temperature was raised to 90° C. to dissolve the polyol and the silicone resin intermediate. When the dissolution was completed, 418 parts by weight of isophthalic acid and 0.5 parts by weight of a catalyst (TIPT) were charged thereinto, and the temperature was raised to 240° C. over 3 to 5 hours while removing condensed water to perform a maintenance reaction. When the acid value of the silicone-modified polyester resin intermediate reached 10, and the viscosity thereof reached 10 P (@175° C., Brookfield CAP 2000+H), the packed column was removed, and the temperature was lowered to 230° C. and the pressure was lowered to 150 torr, thereby removing 110 parts by weight of the condensed water to prepare a silicone-modified polyester resin (B) having a number average molecular weight of 3,400 g/mol, a hydroxyl value of 75 mgKOH/g, an acid value of 4 mgKOH/g, a viscosity of 19 P (@200° C., Brookfield CAP 2000+H), a softening point of 112° C., and a glass transition temperature of 37° C.

### Preparation Example 3: Preparation of Silicone-Modified Polyester Resin (C)

Into a four-neck flask for synthesis equipped with a thermometer, a stirring device, an H-shaped separation pipe, a filling column, a condenser, a nitrogen injection pipe, and a heating device, 318 parts by weight of neopentyl glycol, 68 parts by weight of trimethylol propane, and 303 parts by weight of a silicone resin intermediate (Mn 1,200 g/mol, Mw 2,400 g/mol, phenyl/propyl ratio=1:0.37, and softening point 40° C.) were charged, and while introducing nitrogen (10 cc/min) thereto, the temperature was raised to 90° C. to dissolve the polyol and the silicone resin intermediate. When the dissolution was completed, 418 parts by weight of isophthalic acid and 0.5 parts by weight of a catalyst (TIPT) were charged thereinto, and the temperature was raised to 240° C. over 3 to 5 hours while removing condensed water to perform a maintenance reaction. When the acid value of the silicone-modified polyester resin intermediate reached 10, and the viscosity thereof reached 10 P (@175° C., Brookfield CAP 2000+H), the packed column was removed, and the temperature was lowered to 230° C. and a nitrogen purge (100 cc/min) was performed, thereby removing 110 parts by weight of the condensed water to prepare a silicone-modified polyester resin (C) having a number average molecular weight of 3,200 g/mol, a hydroxyl value of 78 mgKOH/g, an acid value of 4 mgKOH/g, a viscosity of 14 P (@200° C., Brookfield CAP 2000+H), a softening point of 111° C., and a glass transition temperature of 35° C.

### Preparation Example 4: Preparation of Silicone-Modified Polyester Resin (D)

Into a four-neck flask for synthesis equipped with a thermometer, a stirring device, an H-shaped separation pipe, a filling column, a condenser, a nitrogen injection pipe, and a heating device, 318 parts by weight of neopentyl glycol, 68 parts by weight of trimethylol propane, 418 parts by weight of isophthalic acid, and a catalyst (Fascat #4101, Arkema Co.) were charged, and while introducing nitrogen (10 cc/min) thereto, the temperature was raised to 240° C. over 3 to 5 hours to perform a maintenance reaction. When the acid value of the polyester resin intermediate reached 7, and the viscosity thereof reached 8 P (@175° C., Brookfield CAP 2000+H), the packed column was removed, and the temperature was lowered to 130° C., and 303 parts by weight of a silicone resin intermediate (Mn 1,200 g/mol, Mw 2,400 g/mol, phenyl/propyl ratio=1:0.37, and softening point 40° C.) and 0.5 parts by weight of a catalyst (TIPT) were introduced thereto, and the temperature was raised to 230° C. while removing condensed water, and then the pressure was lowered to 150 torr, thereby removing 110 parts by weight of the condensed water to prepare a silicone-modified polyester resin (D) having a number average molecular weight of 3,500 g/mol, a hydroxyl value of 76 mgKOH/g, an acid value of 5 mgKOH/g, a viscosity of 18 P (@200° C., Brookfield CAP 2000+H), a softening point of 113° C., and a glass transition temperature of 36° C., but the resin was discarded since gel particles were generated in the resin.

### Preparation Example 5: Preparation of Silicone-Modified Polyester Resin (E)

Into a four-neck flask for synthesis equipped with a thermometer, a stirring device, an H-shaped separation pipe, a filling column, a condenser, a nitrogen injection pipe, and a heating device, 318 parts by weight of neopentyl glycol, 68 parts by weight of trimethylol propane, 303 parts by weight of a silicone resin intermediate (DC-3074, Dow Co., liquid), 418 parts by weight of isophthalic acid, and 0.5 parts by weight of a catalyst (TIPT) were charged, and the temperature was raised to 240° C. over 3 to 5 hours while removing condensed water to perform a maintenance reaction. When the acid value of the silicone-modified polyester resin intermediate reached 10, and the viscosity thereof reached 3 P (@175° C., Brookfield CAP 2000+H), the packed column was removed, and the temperature was lowered to 230° C. and the pressure was lowered to 150 torr, thereby removing 110 parts by weight of condensed water and methanol to prepare a silicone-modified polyester resin (E) having a number average molecular weight of 3,300 g/mol, a hydroxyl value of 75 mgKOH/g, an acid value of 4 mgKOH/g, a viscosity of 3 P (@200° C., Brookfield CAP 2000+H), a softening point of 97° C., and a glass transition temperature of 30° C., but the glass transition temperature of the resin was not high enough, which caused the occurrence of resin blocking during storage, so that the resin was discarded.

### Preparation Example 6: Preparation of Resin (F)

Into a four-neck flask for synthesis equipped with a thermometer, a stirring device, an H-shaped separation pipe, a filling column, a condenser, a nitrogen injection pipe, and a heating device, 363 parts by weight of neopentyl glycol, 16 parts by weight of trimethylol propane, 48 parts by weight of 1,6-hexanediol, 418 parts by weight of isophthalic acid, and 1.0 part by weight of a catalyst (Fascat #4101) were charged, and while introducing nitrogen (10 cc/min) thereto and removing condensed water, the temperature was raised to 250° C. over 3 to 5 hours to perform a maintenance reaction. When the acid value of the polyester resin intermediate reached 40, and the viscosity thereof reached 30 P (@175° C., Brookfield CAP 2000+H), the packed column was removed, and a 250° C. maintenance reaction was performed while additionally removing condensed water, and then a decompression process to 100 torr at 240° C., thereby removing 147 parts by weight of the condensed water to prepare a polyester resin (F) having a number average molecular weight of 3,300 g/mol, an acid value of 34 mgKOH/g, a viscosity of 30 P (@200° C., Brookfield CAP 2000+H), a softening point of 123° C., and a glass transition temperature of 65° C.

### Preparation Example 7: Preparation of Mixed Resin by Blending Polyester Resin (G) and Silicone Resin

Into a four-neck flask for synthesis equipped with a thermometer, a stirring device, an H-shaped separation pipe, a filling column, a condenser, a nitrogen injection pipe, and a heating device, 318 parts by weight of neopentyl glycol, 68 parts by weight of trimethylol propane, 418 parts by weight of isophthalic acid, and 1.0 part by weight of a catalyst (Fascat #4101) were charged, and while introducing nitrogen (10 cc/min) thereto and removing condensed water, the temperature was raised to 250° C. over 3 to 5 hours to perform a maintenance reaction. When the acid value of the polyester resin intermediate reached 40, and the viscosity thereof reached 30 P (@175° C., Brookfield CAP 2000+H), the packed column was removed, and a 250° C. maintenance reaction was performed while additionally removing condensed water, and then a decompression process was performed to 100 torr at 240° C., thereby removing 147 parts by weight of the condensed water to prepare a polyester resin (G) having a number average molecular weight of 3,300 g/mol, an acid value of 34 mgKOH/g, a viscosity of 30 P (@200° C., Brookfield CAP 2000+H), a softening point of 123° C., and a glass transition temperature of 65° C.

The prepared polyester resin (G) and a silicone resin intermediate (Mn 1,200 g/mol, Mw 2,400 g/mol, phenyl/profile ratio=1:0.37, and softening point 40° C.) were mixed to prepare a mixed resin.

### Experimental Examples 1 to 5

According to the composition described in Table 1 below, each component was put into a mixing tank for premixing, and then melt-dispersed at 100° C. in a disperser to prepare chips. The prepared chips were pulverized with a high-speed mixer to prepare a powder coating composition of each experimental example, wherein the powder coating compositions have an average particle size of 40 μm.

TABLE 1

| Component (wt %) | | Example 1 | Example 2 | Example 3 | Example 4 | Example 5 |
|---|---|---|---|---|---|---|
| Polyester | Resin 1 | 50 | | | | |
| resin | Resin 2 | | 50 | | | |
| | Resin 3 | | | 50 | | |
| | Resin 4 | | | | 50 | |
| | Resin 5 | | | | | 50 |
| Curing agent | Curing agent 1 | 16 | 16 | 16 | 16 | 16 |
| | Curing agent 2 | | | | 4 | |
| Additive | Additive 1 | 1 | 1 | 1 | 1 | 1 |
| | Additive 2 | 0.3 | 0.3 | 0.3 | 0.3 | 0.3 |
| | Additive 3 | 32.7 | 32.7 | 32.7 | 28.7 | 32.7 |

| | | | | | |
|---|---|---|---|---|---|
| Total sum | 100 | 100 | 100 | 100 | 100 |

Resin 1: Silicone-modified polyester resin (A) of Preparation Example 1
Resin 2: Silicone-modified polyester resin (B) of Preparation Example 2
Resin 3: Silicone-modified polyester resin (C) of Preparation Example 3
Resin 4: Polyester resin (F) of Preparation Example 6
Resin 5: Mixed resin of Preparation Example 7 in which polyester resin (G) and silicone resin are blended
Curing agent 1: Blocked polyisocyanate (Vestagon B 1530, Evonik Co., NCO %=14.8−15.7%)
Curing agent 2: Triglycidylisocyanurate (Ew=99.08)
Additive 1: Leveling agent (Acrylic polymer, Resiflow P-67)
Additive 2: Degassing agent (Benzoin)
Additive 3: TiO2

### Properties Evaluation

Properties of the powder coating composition prepared in each Experimental Example were measured as follows, and the results are shown in Table 2 below.

### Preparing Specimen

The powder coating composition prepared in each experimental example was coated on a non-pretreated specimen (CR, cold-roll steel sheet) to a thickness of 50 to 80 μm and baked to prepare a specimen.

### Appearance

Pinholes were observed with the naked eye and evaluated an appearance.

### Accelerated Weatherability

After introducing an accelerated weatherability device (WOM PV3930), the gloss retention, chrominance, and chalking were evaluated by the following methods.

### Gloss Retention Rate

The gloss retention was evaluated using a gloss meter (micro-TRI-gloss, BYK Co., 60° gloss measurement) and by the following equation.

Gloss retention rate (%)=gloss after weatherability evaluation/initial gloss

### Chrominance

Using a color measurement device (Color i7, X-rite Co.), L, a, b values of a coating film after the weatherability evaluation compared to initial L, a, b values thereof were measured to evaluate chrominance by the following equation.

$$Δ E ( {L}^{*} , {a}^{*} , {b}^{*} ) = \{ ( Δ {L}^{*} ) 2 + ( Δ {a}^{*} ) 2 + ( Δ {b}^{*} ) 2 \} 1 / 2$$

### Chalking

After the weatherability evaluation, a predetermined transparent adhesive tape was attached to and detached from the surface of a coating film, and the degree of the adherence of the coating film to the tape was determined and evaluated on a scale of 10 (good) to 1 (poor).

TABLE 2

| | | Example 1 | Example 2 | Example 3 | Example 4 | Example 5 |
|---|---|---|---|---|---|---|
| Appearance | | Good | Good | Poor | Good | Poor |
| Gloss | 1000 hours | 100% | 100% | 100% | 99% | 95% |
| retention rate | 5000 hours | 91% | 92% | 88% | 58% | 78% |
| | 6000 hours | 88% | 87% | 83% | 38% | 63% |
| | 8000 hours | 82% | 84% | 76% | 13% | 66% |
| Chrominance | 1000 hours | 0.4 | 0.3 | 0.3 | 0.3 | 0.5 |
| | 5000 hours | 0.6 | 0.5 | 0.5 | 0.4 | 0.6 |
| | 6000 hours | 0.7 | 0.6 | 0.6 | 0.4 | 0.7 |
| | 8000 hours | 0.7 | 0.6 | 0.6 | 0.7 | 0.7 |
| Chalking | 1000 hours | 10 | 10 | 8 | 8 | 6 |
| | 5000 hours | 10 | 10 | 8 | 8 | 6 |
| | 6000 hours | 10 | 10 | 8 | 8 | 6 |
| | 8000 hours | 10 | 10 | 8 | 8 | 6 |

As shown in Table 2, the coating compositions of Experimental Example 1 and Experimental Example 2, which respectively used the silicone-modified polyester resin (A) and the silicone-modified polyester resin (B) according to the present invention, showed excellent properties across the measurement items. On the other hand, particles were observed in the coating composition of Experimental Example 3 containing the silicone-modified polyester resin (C) prepared without the application of a vacuum after preparing the silicone-modified polyester resin intermediate, and the coating composition of Experimental Example 4 containing the polyester resin (F) prepared without the application of a silicone resin intermediate showed a low gloss retention rate. In addition, in the coating composition of Experimental Example 5, which used a mixed resin in which the polyester resin (G) and a silicone resin intermediate were simply blended, instead of a silicone-modified polyester resin, the condensed water generated during the curing process was not removed, resulting in pinholes, so that the appearance was degraded and accordingly, the gloss and chrominance were also decreased.

Meanwhile, the silicone-modified polyester resin (D) that was modified with silicone after preparing the polyester intermediate had gel particles generated in the resin, so that a coating was not prepared, which made it impossible to evaluate properties thereof, and the silicone-modified polyester resin (E) that was prepared by simultaneously reacting an alcohol, an acid, and a silicone intermediate was agglomerated during storage, which made it impossible to evaluate properties thereof.

What is claimed is:

1. A silicone-modified polyester resin prepared by a method comprising:
reacting a polol monomer with a silicone resin intermediate to prepare a prepolymer;
adding a polyacid monomer to the prepolymer and subjecting the mixture to a condensation reaction to prepare a silicone-modified polyester intermediate; and
removing condensed water by applying a vacuum,
wherein the silicone-modified polyester resin has a glass transition temperature of 35° C. or higher, and a hydroxyl value of 20 to 100 mgKOH/g.

2. The silicone-modified polyester resin of claim 1, wherein the silicone-modified polyester resin has a number average molecular weight of 2,500 to 6,000 g/mol, an acid value of 1 to 10 mgKOH/g, a viscosity (200° C.) of 10 to 50 P, and a softening point of 100 to 130° C.

3. The silicone-modified polyester resin of claim 1, wherein the silicone resin intermediate is a compound represented by Formula 1 below: 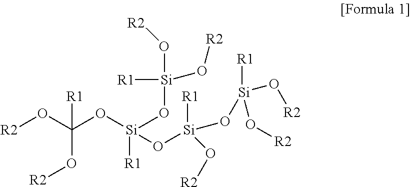
wherein in Formula 1 above,
R1 is methyl, propyl, or phenyl, and
R2 is methyl or hydrogen.

4. The silicone-modified polyester resin of claim 3, wherein R1 is phenyl and methyl or propyl at a ratio of 1:0 to 1.

5. The silicone-modified polyester resin of claim 1, wherein the silicone resin intermediate has a number average molecular weight of 500 to 3,000 g/mol, a weight average molecular weight of 1,200 to 4,000 g/mol, and a softening point of 20 to 85° C.

6. The silicone-modified polyester resin of claim 1, wherein the silicone-modified polyester resin comprises 25 to 45 wt % of the polyol monomer, 20 to 40 wt % of the polyacid monomer, and 20 to 50 wt % of the silicone resin intermediate, based on the total weight of a silicone-modified polyester resin composition.

7. A powder coating composition comprising a silicone-modified polyester resin, a curing agent, and a pigment,
wherein the silicone-modified polyester resin is the silicone-modified polyester resin of claim 1.

8. The powder coating composition of claim 7, wherein the powder coating composition comprises 40 to 60 wt % of the silicone-modified polyester resin, 5 to 20 wt % of the curing agent, and 0.1 to 50 wt % of the pigment, based on the total weight of the powder coating composition.
